(19) United States
(12) Patent Application Publication
(10) Pub. No.: US 2015/0347895 A1
(43) Pub. Date: Dec. 3, 2015

(54) DERIVING RELATIONSHIPS FROM OVERLAPPING LOCATION DATA

(71) Applicant: QUALCOMM Incorporated, San Diego, CA (US)

(72) Inventors: Sarah GLICKFIELD, St. Louis, MO (US); Isaac David GUEDALIA, Beit-Shemesh (IL); Bracha Lea WITTOW-LEDERMAN, Beit-Shemesh (IL)

(21) Appl. No.: 14/698,697

(22) Filed: Apr. 28, 2015

Related U.S. Application Data
(60) Provisional application No. 62/006,564, filed on Jun. 2, 2014.
(60) Provisional application No. 62/022,068, filed on Jul. 8, 2014.

(51) Int. Cl. G06N 3/02; H04L 29/12

(52) U.S. Cl. CPC G06N 3/02; H04L 61/609

(57) ABSTRACT

Method and systems for deriving relationships from overlapping time and location data are disclosed. A first user device receives time and location data for a first user, the time and location data for the first user representing locations of the first user over time, reduces the time and location data for the first user around a first plurality of artificial neurons, wherein each of the first plurality of artificial neurons represents a location of the first user during a first time, transmits the reduced time and location data for the first user to a server, wherein the server determines whether or not the first user and a second user are related based on determining that the first user and the second user have an artificial neuron in common among the first plurality of artificial neurons and a second plurality of artificial neurons.

### CROSS-REFERENCE TO RELATED APPLICATIONS

The present Application for Patent claims the benefit of U.S. Provisional Application No. 62/006,564, entitled “DERIVING USER CHARACTERISTICS FROM USERS' LOG FILES,” filed Jun. 2, 2014, and U.S. Provisional Application No. 62/022,068, entitled “DERIVING RELATIONSHIPS FROM OVERLAPPING LOCATION DATA,” filed Jul. 8, 2014, assigned to the assignee hereof, and expressly incorporated herein by reference in their entirety.

### INTRODUCTION

Aspects of the disclosure are directed to deriving relationships from overlapping location data.

User devices generally track information related to a user's use of the device, such as the location of the device, battery usage, WiFi access, and/or interactions with other devices (e.g., emails, calls, short message service (SMS) messages, multimedia message service (MMS) messages, web browsing history, proximity detections, etc.), and store this information in user log files. User logs reporting on location data, among other data, provides an analysis opportunity that can potentially lend insight into a user's relationships with other users.

### SUMMARY

The following presents a simplified summary relating to one or more aspects and/or embodiments associated with the mechanisms disclosed herein for deriving relationships from overlapping location data. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

A method for deriving relationships from overlapping time and location data include receiving, at a first user device, time and location data for a first user, the time and location data for the first user representing locations of the first user over time, wherein a second user device receives time and location data for a second user, the time and location data for the second user representing locations of the second user over time, reducing, at the first user device, the time and location data for the first user around a first plurality of artificial neurons, wherein each of the first plurality of artificial neurons represents a location of the first user during a first time, wherein the second user device reduces the time and location data for the second user around a second plurality of artificial neurons, wherein each of the second plurality of artificial neurons represents a location of the second user during a second time, transmitting, by the first user device, the reduced time and location data for the first user to a server, wherein the second user device transmits the reduced time and location data for the second user to the server, and wherein the server determines whether or not the first user and the second user are related based on determining that the first user and the second user have an artificial neuron in common among the first plurality of artificial neurons and the second plurality of artificial neurons.

An apparatus for deriving relationships from overlapping time and location data includes a processor that receives time and location data for a first user of a first user device, the time and location data for the first user representing locations of the first user over time, and reduces the time and location data for the first user around a first plurality of artificial neurons, each of the first plurality of artificial neurons representing a location of the first user during a first time, wherein a second user device receives time and location data for a second user, the time and location data for the second user representing locations of the second user over time, and wherein the second user device reduces the time and location data for the second user around a second plurality of artificial neurons, wherein each of the second plurality of artificial neurons represents a location of the second user during a second time, and a transceiver that transmits the reduced time and location data for the first user to a server, wherein the second user device transmits the reduced time and location data for the second user to the server, wherein the server determines whether or not the first user and the second user are related based on determining that the first user and the second user have an artificial neuron in common among the first plurality of artificial neurons and the second plurality of artificial neurons.

An apparatus for deriving relationships from overlapping time and location data includes means for receiving, at a first user device, time and location data for a first user, the time and location data for the first user representing locations of the first user over time, wherein a second user device receives time and location data for a second user, the time and location data for the second user representing locations of the second user over time, means for reducing, at the first user device, the time and location data for the first user around a first plurality of artificial neurons, wherein each of the first plurality of artificial neurons represents a location of the first user during a first time, wherein the second user device reduces the time and location data for the second user around a second plurality of artificial neurons, wherein each of the second plurality of artificial neurons represents a location of the second user during a second time, and means for transmitting, by the first user device, the reduced time and location data for the first user to a server, wherein the second user device transmits the reduced time and location data for the second user to the server, wherein the server determines whether or not the first user and the second user are related based on determining that the first user and the second user have an artificial neuron in common among the first plurality of artificial neurons and the second plurality of artificial neurons.

A non-transitory computer-readable medium for deriving relationships from overlapping time and location data includes at least one instruction for receiving, at a first user device, time and location data for a first user, the time and location data for the first user representing locations of the first user over time, wherein a second user device receives time and location data for a second user, the time and location data for the second user representing locations of the second user over time, at least one instruction for reducing, at the first user device, the time and location data for the first user around a first plurality of artificial neurons, wherein each of the first plurality of artificial neurons represents a location of the first user during a first time, wherein the second user device reduces the time and location data for the second user around a second plurality of artificial neurons, wherein each of the second plurality of artificial neurons represents a location of the second user during a second time, and at least one instruction for transmitting, by the first user device, the reduced time and location data for the first user to a server, wherein the second user device transmits the reduced time and location data for the second user to the server, wherein the server determines whether or not the first user and the second user are related based on determining that the first user and the second user have an artificial neuron in common among the first plurality of artificial neurons and the second plurality of artificial neurons.

Other objects and advantages associated with the mechanisms disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an aspect of the disclosure.

FIG. 2 is a block diagram illustrating various components of an exemplary user equipment (UE).

FIG. 3 illustrates a communication device that includes logic configured to perform functionality in accordance with an aspect of the disclosure.

FIG. 4 illustrates a server in accordance with an embodiment of the disclosure.

FIGS. 5A-F illustrate an exemplary high-level process for determining relationships between users according to an aspect of the disclosure.

FIG. 6A illustrates an exemplary conventional system in which user devices send logs of user data to a server to be processed.

FIG. 6B illustrates an exemplary system according to an aspect of the disclosure in which the various user devices and the server illustrated in FIG. 6A share processing responsibility.

FIG. 7 illustrates an exemplary flow for determining relationships using locally built models of time-location data.

FIGS. 8A-D illustrate an exemplary process for creating a grammar from clustered data.

FIG. 9 illustrates an exemplary flow for creating a grammar from clustered data.

FIG. 10 illustrates an exemplary flow for deriving relationships from overlapping time and location data.

FIGS. 11-12 are simplified block diagrams of several sample aspects of apparatuses configured to support communication as taught herein.

### DETAILED DESCRIPTION

The present Application for Patent is related to the U.S. Patent Application entitled “DERIVING USER CHARACTERISTICS FROM USERS' LOG FILES,” having Attorney Docket No. 141209 and filed concurrently herewith, and U.S. application Ser. No. 13/906,169, entitled “A PARALLEL METHOD FOR AGGLOMERATIVE CLUSTERING OF NON-STATIONARY DATA,” filed May 30, 2013, assigned to the assignee hereof, and expressly incorporated herein by reference in their entirety.

The disclosure is related to deriving relationships from overlapping time and location data. A first user device receives time and location data for a first user, the time and location data for the first user representing locations of the first user over time, wherein a second user device receives time and location data for a second user, the time and location data for the second user representing locations of the second user over time, reduces the time and location data for the first user around a first plurality of artificial neurons, wherein each of the first plurality of artificial neurons represents a location of the first user during a first time, wherein the second user device reduces the time and location data for the second user around a second plurality of artificial neurons, wherein each of the second plurality of artificial neurons represents a location of the second user during a second time, transmits the reduced time and location data for the first user to a server, wherein the second user device transmits the reduced time and location data for the second user to the server, and wherein the server determines whether or not the first user and the second user are related based on determining that the first user and the second user have an artificial neuron in common among the first plurality of artificial neurons and the second plurality of artificial neurons.

These and other aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT,” a “wireless device,” a “subscriber device,” a “subscriber terminal,” a “subscriber station,” a “user terminal” or UT, a “mobile terminal,” a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

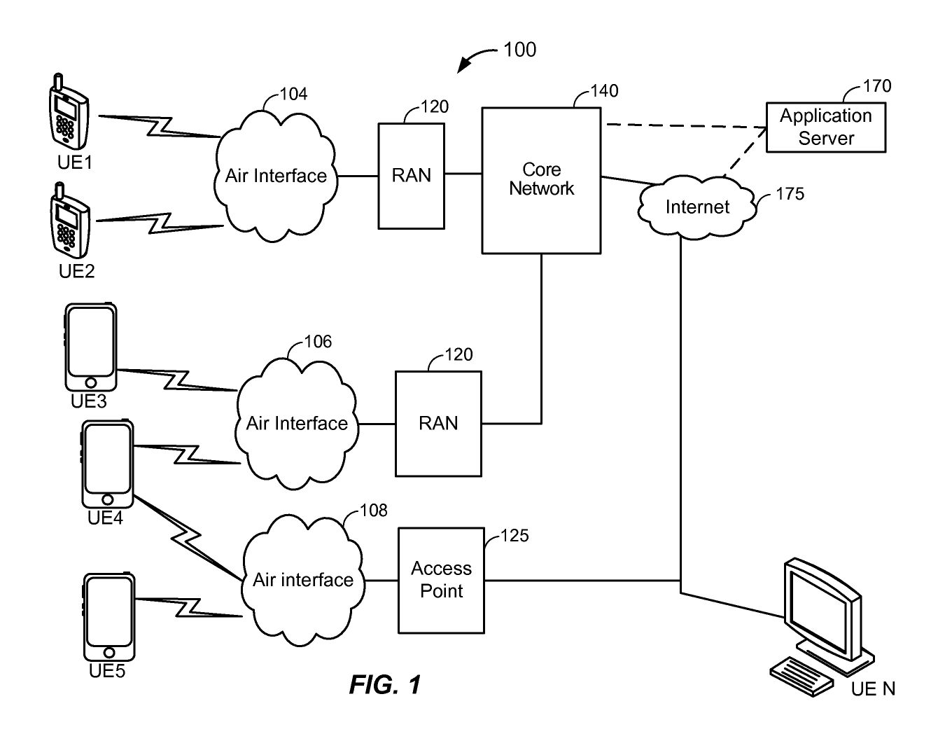

FIG. 1 illustrates a high-level system architecture of a wireless communications system 100 in accordance with an aspect of the disclosure. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or personal computer (PC).

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., Code Division Multiple Access (CDMA), Evolution-Data Optimized (EV-DO), Evolved High Rate Packet Data (eHRPD), Global System of Mobile Communication (GSM), Enhanced Data rates for GSM Evolution (EDGE), Wideband CDMA (W-CDMA), Long-Term Evolution (LTE), etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, an application server 170 is shown as connected to the Internet 175, the core network 140, or both. The application server 170 can be implemented as a plurality of structurally separate servers, or alternately may correspond to a single server. As will be described below in more detail, the application server 170 is configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175.

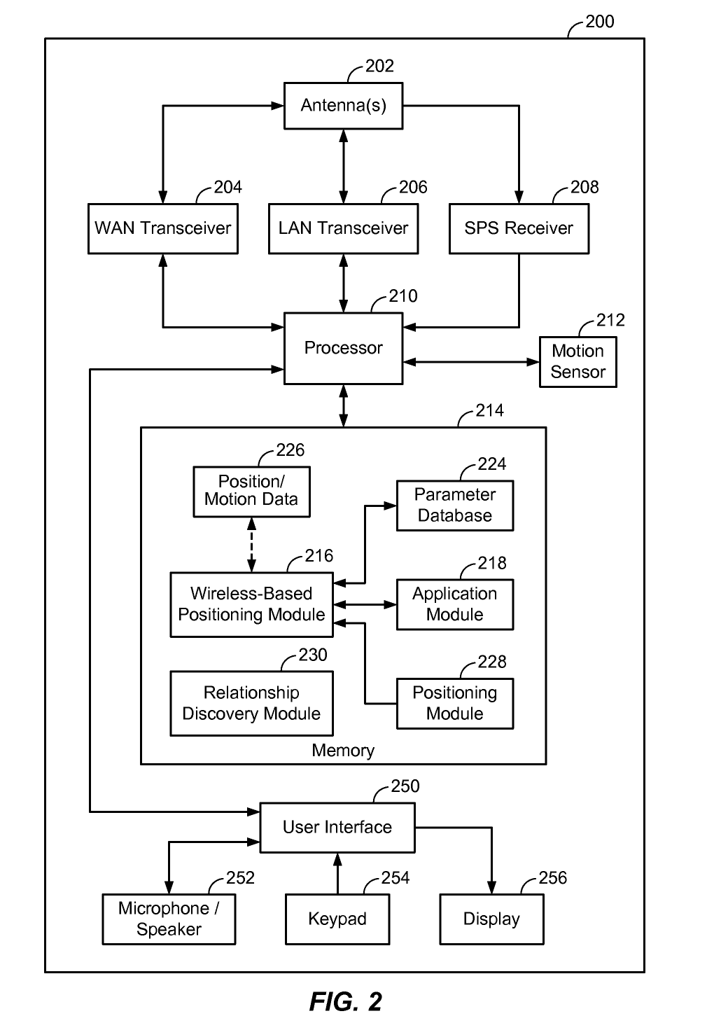

FIG. 2 is a block diagram illustrating various components of an exemplary UE 200. For the sake of simplicity, the various features and functions illustrated in the box diagram of FIG. 2 are connected together using a common bus which is meant to represent that these various features and functions are operatively coupled together. Those skilled in the art will recognize that other connections, mechanisms, features, functions, or the like, may be provided and adapted as necessary to operatively couple and configure an actual portable wireless device. Further, it is also recognized that one or more of the features or functions illustrated in the example of FIG. 2 may be further subdivided or two or more of the features or functions illustrated in FIG. 2 may be combined.

The UE 200 may include one or more wide area network (WAN) transceiver(s) 204 that may be connected to one or more antennas 202. The WAN transceiver 204 comprises suitable devices, hardware, and/or software for communicating with and/or detecting signals to/from WAN-WAPs, such as access point 125, and/or directly with other wireless devices within a network. In one aspect, the WAN transceiver 204 may comprise a CDMA communication system suitable for communicating with a CDMA network of wireless base stations; however in other aspects, the wireless communication system may comprise another type of cellular telephony network, such as, for example, TDMA or GSM. Additionally, any other type of wide area wireless networking technologies may be used, for example, WiMAX (802.16), etc. The UE 200 may also include one or more local area network (LAN) transceivers 206 that may be connected to one or more antennas 202. The LAN transceiver 206 comprises suitable devices, hardware, and/or software for communicating with and/or detecting signals to/from LAN-WAPs, such as access point 125, and/or directly with other wireless devices within a network. In one aspect, the LAN transceiver 206 may comprise a Wi-Fi (802.11x) communication system suitable for communicating with one or more wireless access points; however in other aspects, the LAN transceiver 206 comprise another type of local area network, personal area network, (e.g., Bluetooth). Additionally, any other type of wireless networking technologies may be used, for example, Ultra Wide Band, ZigBee, wireless USB etc.

As used herein, the abbreviated term “wireless access point” (WAP) may be used to refer to LAN-WAPs and/or WAN-WAPs. Specifically, in the description presented below, when the term “WAP” is used, it should be understood that embodiments may include a UE 200 that can exploit signals from a plurality of LAN-WAPs, a plurality of WAN-WAPs, or any combination of the two. The specific type of WAP being utilized by the UE 200 may depend upon the environment of operation. Moreover, the UE 200 may dynamically select between the various types of WAPs in order to arrive at an accurate position solution. In other embodiments, various network elements may operate in a peer-to-peer manner, whereby, for example, the UE 200 may be replaced with the WAP, or vice versa. Other peer-to-peer embodiments may include another UE (not shown) acting in place of one or more WAP.

A satellite positioning system (SPS) receiver 208 may also be included in the UE 200. The SPS receiver 208 may be connected to the one or more antennas 202 for receiving satellite signals. The SPS receiver 208 may comprise any suitable hardware and/or software for receiving and processing SPS signals. The SPS receiver 208 requests information and operations as appropriate from the other systems, and performs the calculations necessary to determine the UE 200's position using measurements obtained by any suitable SPS algorithm.

A motion sensor 212 may be coupled to a processor 210 to provide movement and/or orientation information which is independent of motion data derived from signals received by the WAN transceiver 204, the LAN transceiver 206 and the SPS receiver 208.

By way of example, the motion sensor 212 may utilize an accelerometer (e.g., a microelectromechanical systems (MEMS) device), a gyroscope, a geomagnetic sensor (e.g., a compass), an altimeter (e.g., a barometric pressure altimeter), and/or any other type of movement detection sensor. Moreover, the motion sensor 212 may include a plurality of different types of devices and combine their outputs in order to provide motion information. For example, the motion sensor 212 may use a combination of a multi-axis accelerometer and orientation sensors to provide the ability to compute positions in 2-D and/or 3-D coordinate systems.

The processor 210 may be connected to the WAN transceiver 204, LAN transceiver 206, the SPS receiver 208 and the motion sensor 212. The processor 210 may include one or more microprocessors, microcontrollers, and/or digital signal processors that provide processing functions, as well as other calculation and control functionality. The processor 210 may also include memory 214 for storing data and software instructions for executing programmed functionality within the UE 200. The memory 214 may be on-board the processor 210 (e.g., within the same integrated circuit (IC) package), and/or the memory may be external memory to the processor and functionally coupled over a data bus. The functional details associated with aspects of the disclosure will be discussed in more detail below.

A number of software modules and data tables may reside in memory 214 and be utilized by the processor 210 in order to manage both communications and positioning determination functionality. As illustrated in FIG. 2, memory 214 may include and/or otherwise receive a wireless-based positioning module 216, an application module 218, and a positioning module 228. One should appreciate that the organization of the memory contents as shown in FIG. 2 is merely exemplary, and as such the functionality of the modules and/or data structures may be combined, separated, and/or be structured in different ways depending upon the implementation of the UE 200.

The application module 218 may be a process running on the processor 210 of the UE 200, which requests position information from the wireless-based positioning module 216. Applications typically run within an upper layer of the software architectures. The wireless-based positioning module 216 may derive the position of the UE 200 using information derived from time information measured from signals exchanged with a plurality of WAPs. In order to accurately determine position using time-based techniques, reasonable estimates of time delays, introduced by the processing time of each WAP, may be used to calibrate/adjust the time measurements obtained from the signals. As used herein, these time delays are referred to as “processing delays.”

Calibration to further refine the processing delays of the WAPs may be performed using information obtained by the motion sensor 212. In one embodiment, the motion sensor 212 may directly provide position and/or orientation data to the processor 210, which may be stored in memory 214 in the position/motion data module 226. In other embodiments, the motion sensor 212 may provide data that should be further processed by processor 210 to derive information to perform the calibration. For example, the motion sensor 212 may provide acceleration and/or orientation data (single or multi-axis) which can be processed using positioning module 228 to derive position data for adjusting the processing delays in the wireless-based positioning module 216.

After calibration, the position may then be output to the application module 218 in response to its aforementioned request. In addition, the wireless-based positioning module 216 may utilize a parameter database 224 for exchanging operational parameters. Such parameters may include the determined processing delays for each WAP, the WAPs positions in a common coordinate frame, various parameters associated with the network, initial processing delay estimates, etc.

In other embodiments, the additional information may optionally include auxiliary position and/or motion data which may be determined from other sources besides the motion sensor 212, such as from SPS measurements. The auxiliary position data may be intermittent and/or noisy, but may be useful as another source of independent information for estimating the processing delays of the WAPs depending upon the environment in which the UE 200 is operating.

For example, in some embodiments, data derived from the SPS receiver 208 may supplement the position data supplied by the motion sensor 212 (either directly from the position/motion data module 226 or derived by the positioning module 228). In other embodiments, the position data may be combined with data determined through additional networks using non-RTT techniques (e.g., advanced forward link trilateration (AFLT) within a CDMA network). In certain implementations, the motion sensor 212 and/or the SPS receiver 214 may provide all or part of the auxiliary position/motion data 226 without further processing by the processor 210. In some embodiments, the auxiliary position/motion data 226 may be directly provided by the motion sensor 212 and/or the SPS receiver 208 to the processor 210.

Memory 214 may further include a relationship discovery module 230 executable by the processor 210. As will be described herein, where the UE 200 is configured to derive relationships from overlapping time and location data, the relationship discovery module 230, when executed by the processor 210, receives time and location data for a first user, the time and location data for the first user representing locations of the first user over time, reduces the time and location data for the first user around a first plurality of artificial neurons, each of the first plurality of artificial neurons representing a location of the first user during a first time, and causes the UE 200 to transmit, e.g., via WAN transceiver 204 or LAN transceiver 206, the reduced time and location data for the first user to a server, such as application server 170. A second user device having a relationship discovery module 230 may receive time and location data for a second user, the time and location data for the second user representing locations of the second user over time, reduce the time and location data for the second user around a second plurality of artificial neurons, wherein each of the second plurality of artificial neurons represents a location of the second user during a second time, and transmit the reduced time and location data for the second user to the server. The server can then determine whether or not the first user and the second user are related based on determining that the first user and the second user have an artificial neuron in common among the first plurality of artificial neurons and the second plurality of artificial neurons.

While the modules shown in FIG. 2 are illustrated in the example as being contained in the memory 214, it is recognized that in certain implementations such procedures may be provided for or otherwise operatively arranged using other or additional mechanisms. For example, all or part of the wireless-based positioning module 216 and/or the application module 218 may be provided in firmware. Additionally, while in this example the wireless-based positioning module 216 and the application module 218 are illustrated as being separate features, it is recognized, for example, that such procedures may be combined together as one procedure or perhaps with other procedures, or otherwise further divided into a plurality of sub-procedures.

The processor 210 may include any form of logic suitable for performing at least the techniques provided herein. For example, the processor 210 may be operatively configurable based on instructions in the memory 214 to selectively initiate one or more routines that exploit motion data for use in other portions of the UE 200. The processor 210 may further be

The UE 200 may include a user interface 250 which provides any suitable interface systems, such as a microphone/speaker 252, keypad 254, and display 256 that allows user interaction with the UE 200. The microphone/speaker 252 provides for voice communication services using the WAN transceiver 204 and/or the LAN transceiver 206. The keypad 254 comprises any suitable buttons for user input. The display 256 comprises any suitable display, such as a backlit liquid crystal display (LCD), and may further include a touch screen display for additional user input modes.

As used herein, the UE 200 may be any portable or movable device or machine that is configurable to acquire wireless signals transmitted from, and transmit wireless signals to, one or more wireless communication devices or networks. As shown in FIG. 2, the UE 200 is representative of such a portable wireless device. Thus, by way of example but not limitation, the UE 200 may include a radio device, a cellular telephone device, a computing device, a personal communication system (PCS) device, or other like movable wireless communication equipped device, appliance, or machine. The term “user equipment” is also intended to include devices which communicate with a personal navigation device (PND), such as by short-range wireless, infrared, wire line connection, or other connection—regardless of whether satellite signal reception, assistance data reception, and/or position-related processing occurs at the device or at the PND. Also, “user equipment” is intended to include all devices, including wireless devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above is also considered a “user equipment.”

As used herein, the terms “wireless device,” “mobile station,” “mobile device,” “user equipment,” etc. may refer to any type of wireless communication device which may transfer information over a network and also have position determination and/or navigation functionality. The wireless device may be any cellular mobile terminal, personal communication system (PCS) device, personal navigation device, laptop, personal digital assistant, or any other suitable device capable of receiving and processing network and/or SPS signals.

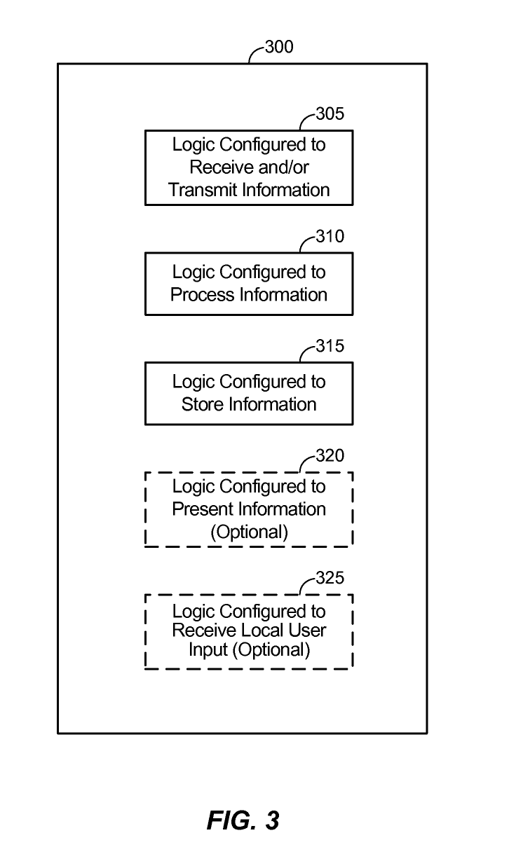

FIG. 3 illustrates a communication device 300 that includes logic configured to perform functionality. The communication device 300 can correspond to any of the above-noted communication devices, including but not limited to UE 200, any component of the RAN 120, any component of the core network 140, any components coupled with the core network 140 and/or the Internet 175 (e.g., the application server 170), and so on. Thus, communication device 300 can correspond to any electronic device that is configured to communicate with (or facilitate communication with) one or more other entities over the wireless communications system 100 of FIG. 1.

Referring to FIG. 3, the communication device 300 includes logic configured to receive and/or transmit information 305. In an example, if the communication device 300 corresponds to a wireless communications device (e.g., UE 200), the logic configured to receive and/or transmit information 305 can include a wireless communications interface (e.g., Bluetooth, WiFi, 2G, CDMA, W-CDMA, 3G, 4G, LTE, etc.) such as a wireless transceiver and associated hardware (e.g., a radio frequency (RF) antenna, a MODEM, a modulator and/or demodulator, etc.). In another example, the logic configured to receive and/or transmit information 305 can correspond to a wired communications interface (e.g., a serial connection, a universal serial bus (USB) or Firewire connection, an Ethernet connection through which the Internet 175 can be accessed, etc.). Thus, if the communication device 300 corresponds to some type of network-based server (e.g., the application server 170), the logic configured to receive and/or transmit information 305 can correspond to an Ethernet card, in an example, that connects the network-based server to other communication entities via an Ethernet protocol. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include logic configured to receive a stream of data points. The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. The processor included in the logic configured to process information 310 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM, flash memory, ROM, erasable programmable ROM (EPROM), EEPROM, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

The logic configured to store information 315 may further include a relationship discovery module, such as relationship discovery module 230, executable by the logic configured to process information 310. As will be described herein, where the communication device 300 is configured to derive relationships from overlapping time and location data, the relationship discovery module, when executed by the logic configured to process information 310, receives time and location data for a first user, the time and location data for the first user representing locations of the first user over time, reduces the time and location data for the first user around a first plurality of artificial neurons, each of the first plurality of artificial neurons representing a location of the first user during a first time, and causes the UE 200 to transmit, e.g., via WAN transceiver 204 or LAN transceiver 206, the reduced time and location data for the first user to a server, such as application server 170. A second user device having a relationship discovery module, such as relationship discovery module 230, may receive time and location data for a second user, the time and location data for the second user representing locations of the second user over time, reduce the time and location data for the second user around a second plurality of artificial neurons, wherein each of the second plurality of artificial neurons represents a location of the second user during a second time, and transmit the reduced time and location data for the second user to the server. The server can then determine whether or not the first user and the second user are related based on determining that the first user and the second user have an artificial neuron in common among the first plurality of artificial neurons and the second plurality of artificial neurons.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, high-definition multimedia interface (HDMI), etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to UE 200 as shown in FIG. 2, the logic configured to present information 320 can include the display 256 and/or the speaker 252. In a further example, the logic configured to present information 320 can be omitted for certain communication devices, such as network communication devices that do not have a local user (e.g., network switches or routers, remote servers, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to UE 200 as shown in FIG. 2, the logic configured to receive local user input 325 can include the microphone 252, the keypad 254, the display 256, etc. In a further example, the logic configured to receive local user input 325 can be omitted for certain communication devices, such as network communication devices that do not have a local user (e.g., network switches or routers, remote servers, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an aspect that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

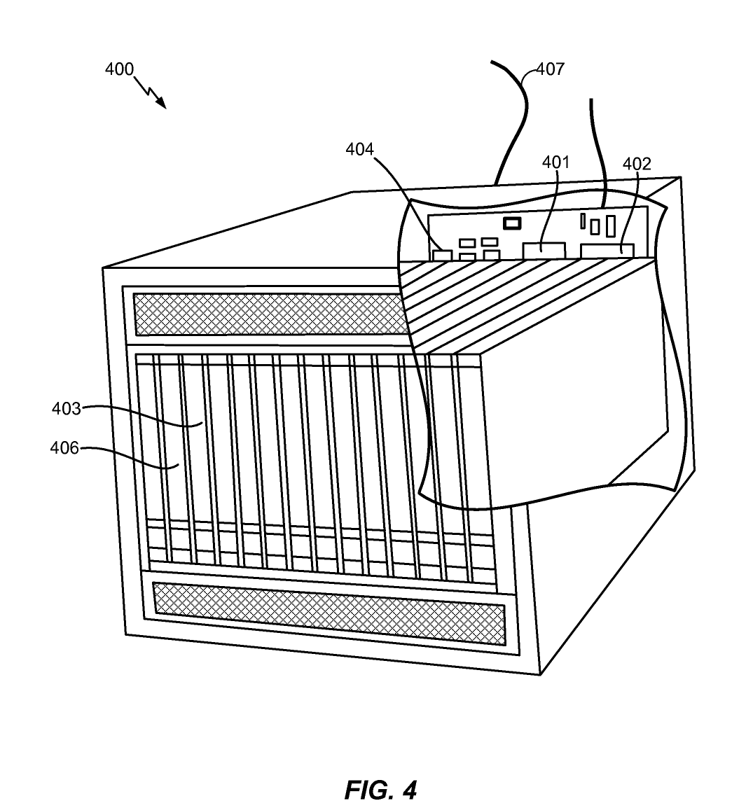

The various embodiments may be implemented on any of a variety of commercially available server devices, such as server 400 illustrated in FIG. 4. In an example, the server 400 may correspond to one example configuration of the application server 170 described above. In FIG. 4, the server 400 includes a processor 400 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to transmit and/or receive information 305 corresponds to the network access ports 304 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to a UE implementation as in 200 of FIG. 2.

Although not illustrated in FIG. 4, the server 400 may also include a relationship discovery module executable by processor 401. As will be described further herein, where the server 400 is configured to derive relationships from overlapping time and location data, the relationship discovery module, when executed by the processor 401, receives, via network access ports 404, reduced time and location data for a first user, the time and location data for the first user reduced around a first plurality of artificial neurons, each of the first plurality of artificial neurons representing a location of the first user during a first time. The relationship discovery module also receives, via network access ports 404, reduced time and location data for at least a second user, the time and location data for the second user reduced around a second plurality of artificial neurons, each of the second plurality of artificial neurons representing a location of the second user during a second time. The relationship discovery module of the server 400 can then determine whether or not the first user and at least the second user are related based on determining that the first user and the second user have an artificial neuron in common among the first plurality of artificial neurons and the second plurality of artificial neurons.

User devices, such as UE 200, generally track information related to a user's use of the device, such as the location of the device, battery usage, WiFi access, and/or interactions with other devices (e.g., emails, calls, SMS messages, MMS messages, web browsing history, proximity detections, etc.), and store this information in user log files. User logs reporting on location data, among other data, provides an analysis opportunity that can potentially lend insight into a user's relationships with other users.

The present disclosure leverages users' location data to learn about their relationships and behavior. Given a user's time and location data, such as GPS coordinates or serving cell identifiers over time, the first step is to discover the significant places to that user, which can be accomplished using a clustering algorithm. The system then compares models built from the data clusters to find similarities between different users.

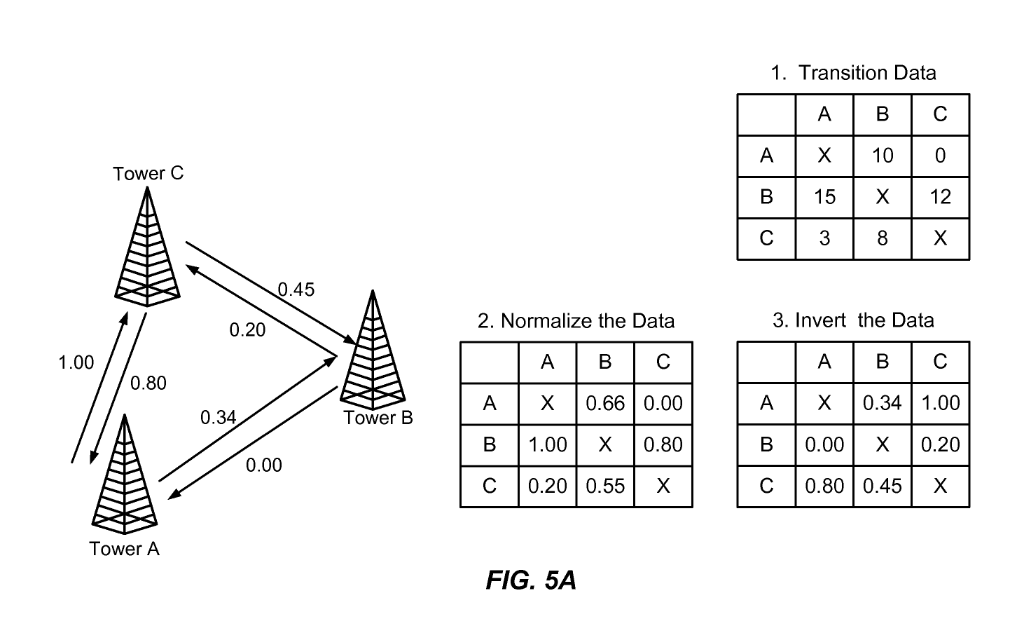

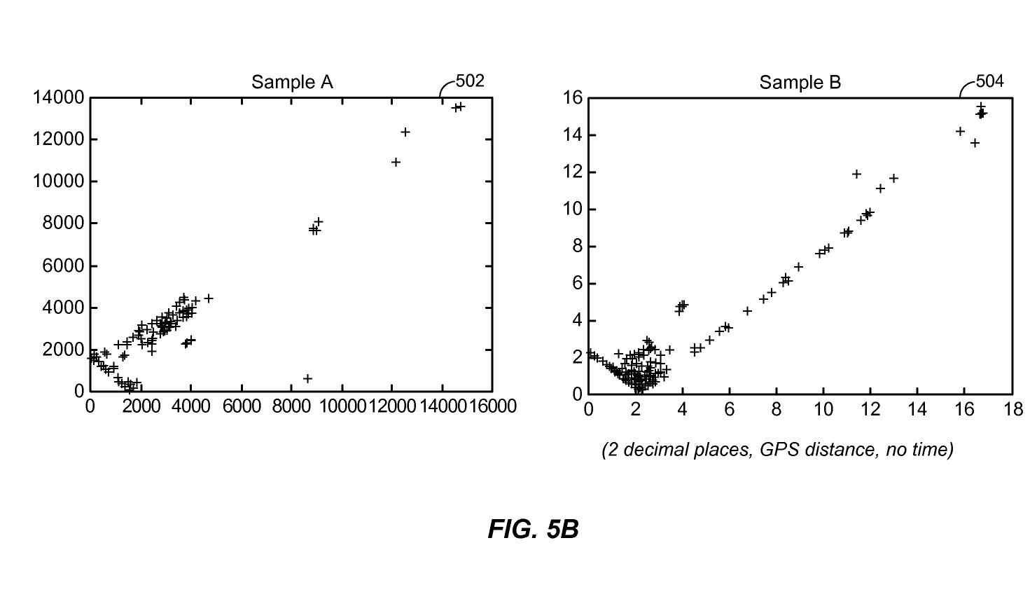

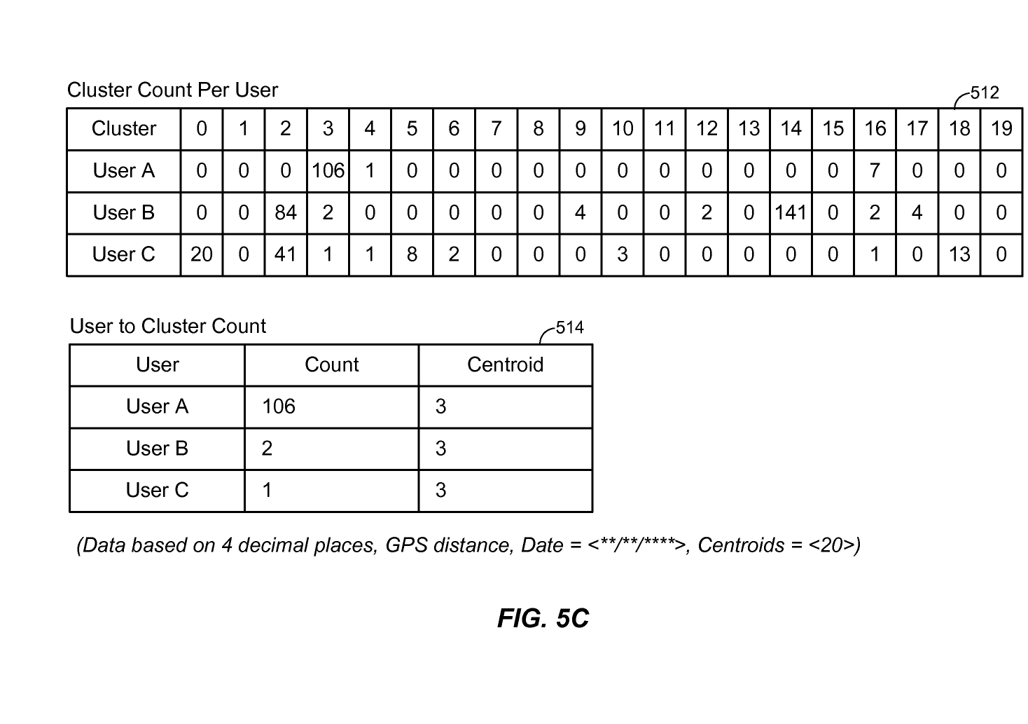

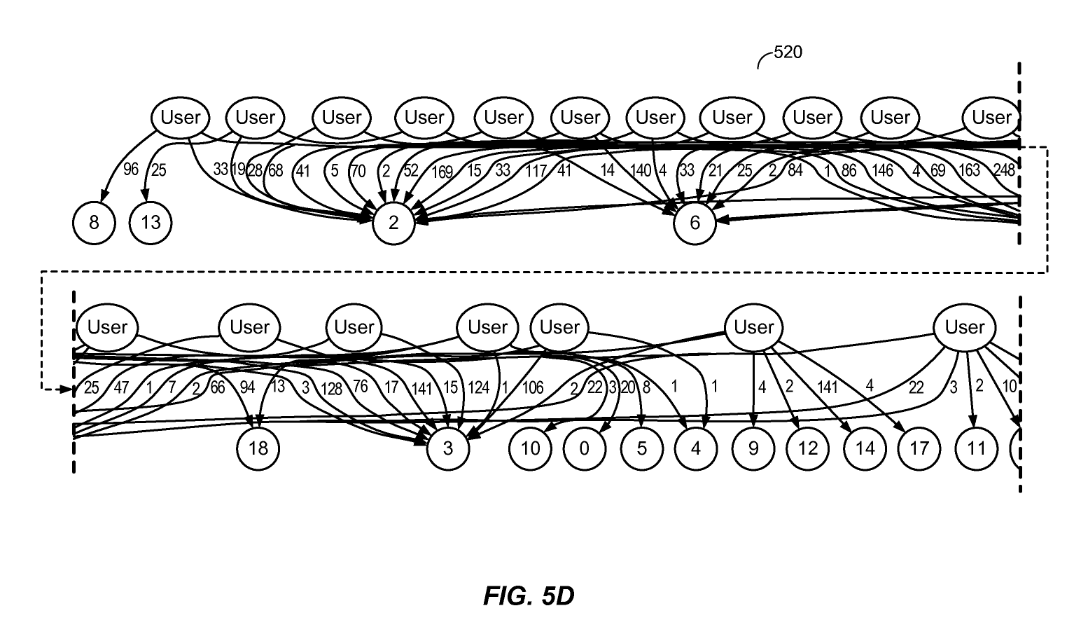

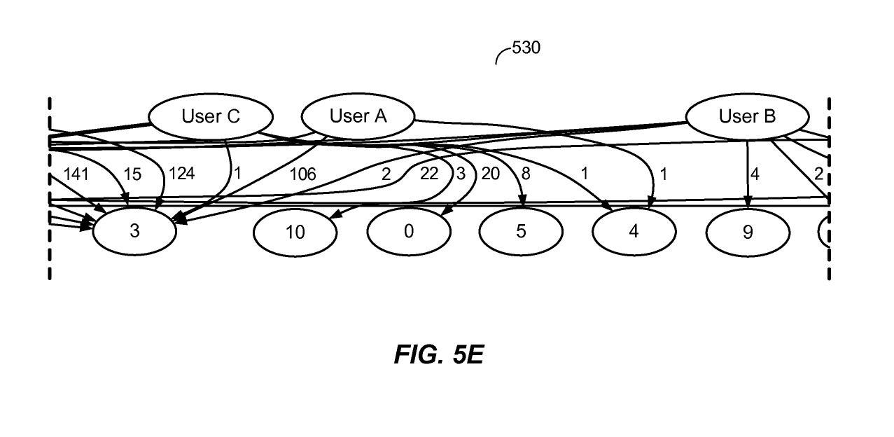

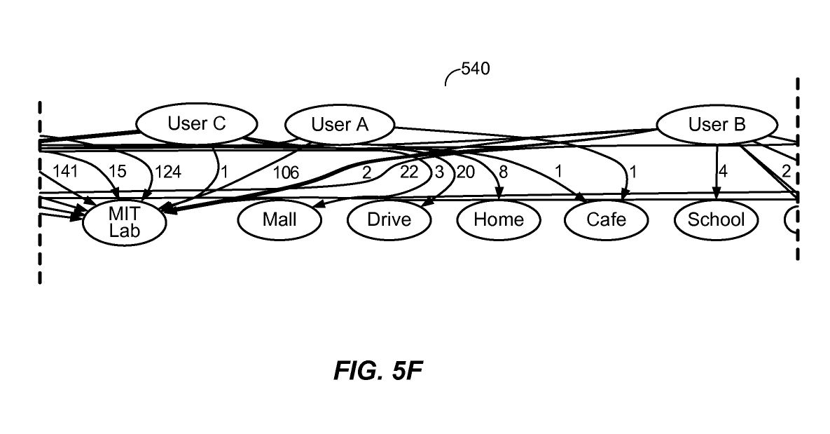

FIGS. 5A-F illustrate an exemplary high-level process for determining relationships between users according to an aspect of the disclosure. The initial step is extracting the values from the log data that the system will cluster. For example, the log data for the user's location at a particular time can be clustered. Location distance can be measured either using geographic distance, e.g., GPS distance, or using transition distances.

The geographic distance is measured by using the GPS coordinates sent stored with the log data. In contrast, the transition distance represents the number of times a device transitions from one location to another. FIG. 5A illustrates an example of determining transition distances. In the example of FIG. 5A, the user's location data includes the serving cell identifier of three cells/base stations, i.e., Tower A, Tower B, and Tower C, to which the user device has been attached over some period of time. The transition distance is determined by measuring the number of times a device transitions from one location (e.g., serving cell) to another (shown in Table 1 of FIG. 5A).

Transitions that occur more frequently indicate a shorter distance between two locations, whereas transitions that occur less frequently indicate a greater distance between two locations. In the example of FIG. 5A, Towers A and C are closest together, as indicated by the transition distances 1.00 (A to C) and 0.80 (C to A).

Next, the extracted data, e.g., the user's location data, is clustered. FIG. 5B illustrates two sets of data points (Sample 1 502 and Sample 2 504) representing the user's locations that have been clustered. This clustering will be described in further detail below.

For each user, the system then identifies to which cluster(s) their location data belongs. FIG. 5C illustrates two tables 512 and 514 representing the cluster count per user (table 512) and the user to cluster count (table 514). As shown in the cluster count per user table 512, User A was at the locations corresponding to clusters 3, 4, and 7 106, 1, and 7 times, respectively. As can be seen in the cluster count per user table 512, and as shown in the user to cluster count table 514, each user was at the location corresponding to cluster 3 at some point in time. Depending on the implementation, the point in time may be a common point in time, e.g., the same hour, the same day, the same week, etc., but it need not be.

Next, as illustrated in FIG. 5D, the system builds a graph 520 representing a mapping between the users and the clusters to which each user belongs. To determine the relationships between users, the system can identify which users share clusters. FIG. 5E illustrates a graph 530 for Users A, B, and C shown in FIG. 5C. As illustrated in FIG. 5C and as shown in FIG. 5E, Users A, B, and C have cluster 3 in common, and are thus related via cluster 3. As such, it can be inferred that there is some relationship between Users A, B, and C.

Over time, the cluster numbers can be replaced with semantic labels, as illustrated in graph 540 of FIG. 5F. To do so, the system generates a grammar describing patterns of user behavior. Once there are enough data points around a given centroid (which may represent a particular location), the system looks up possible semantic labels for the centroid. For example, a particular centroid may be associated with the labels “Starbucks,” “coffee shop,” “breakfast,” “work” (as in the user's place of employment), etc. The system then analyzes the sequence in which the data points were clustered around the various centroids using, for example, the SEQUITUR algorithm. Over time, as patterns emerge in the grammar, the system can determine what a particular location means to the user and assign one of the possible semantic labels accordingly.

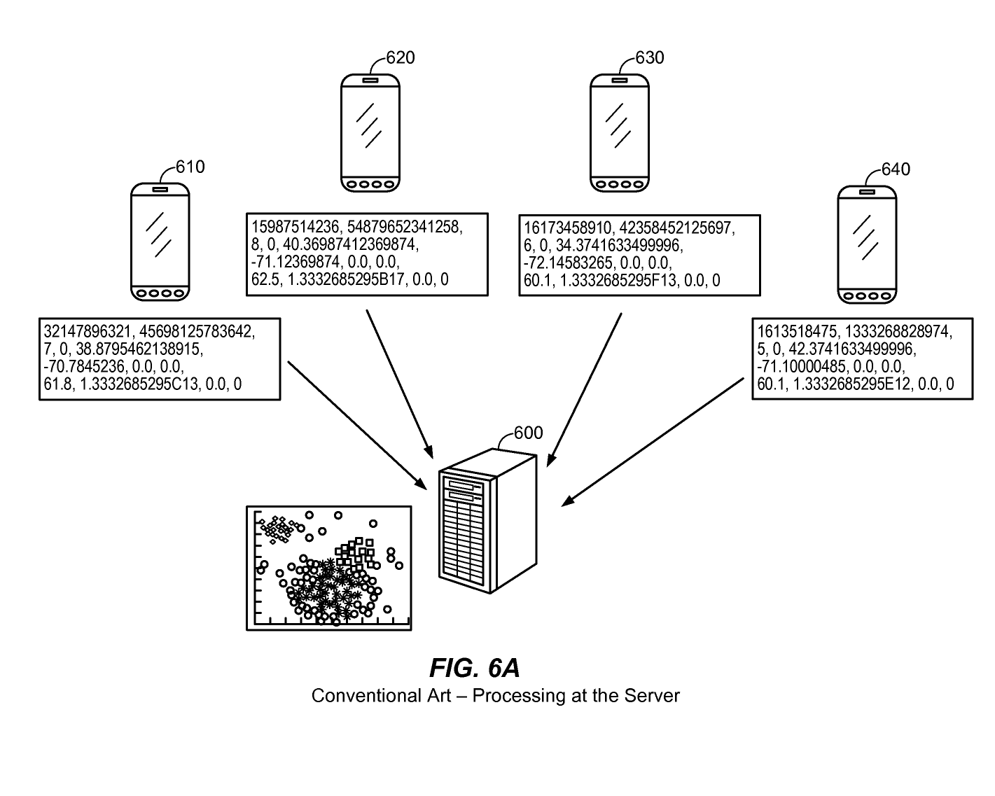

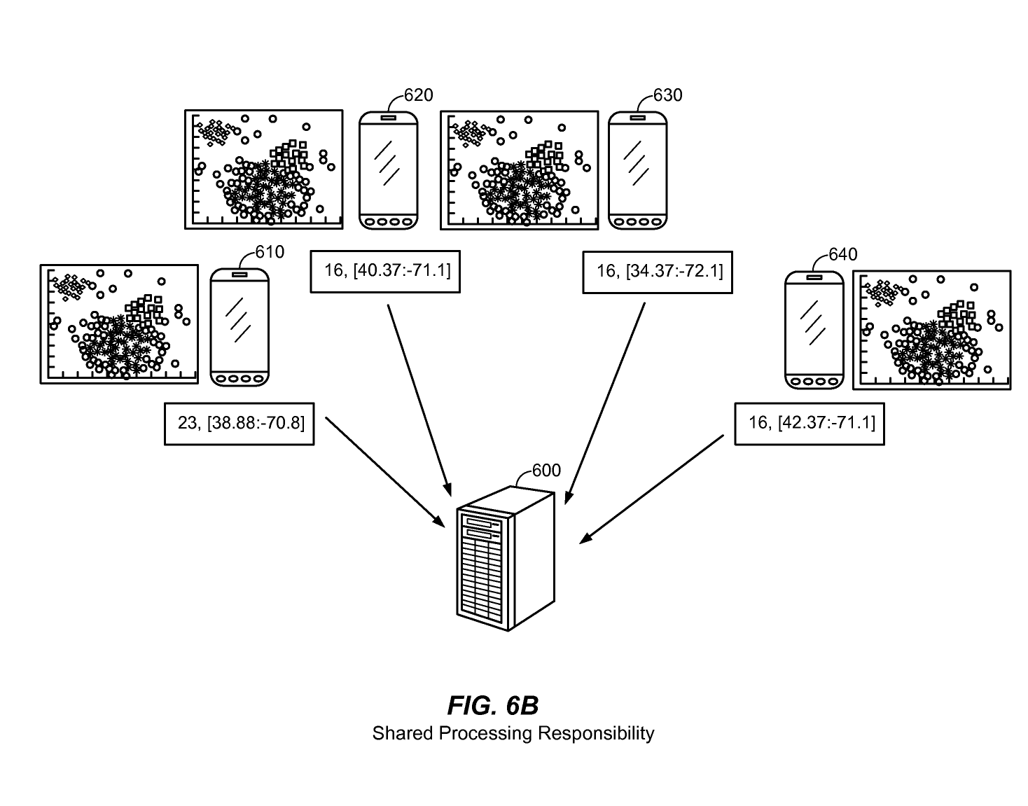

FIG. 6A illustrates an exemplary system in which user devices 610-640, such as UE 200, send logs of user data to a server 600, such as application server 170, to be processed. For example, the server 600 may have processed the received user log data by clustering the data.

In contrast, FIG. 6B illustrates an exemplary system in which the various user devices 610-640 and the server 600 share processing responsibility. For instance, each user device 610-640 may perform feature extraction and clustering of its own user data, and the server 600 may perform data matching. Further, although not illustrated in FIG. 6B, each of user devices 610-640 and server 600 may include a relationship discovery module to perform the functionality described herein.

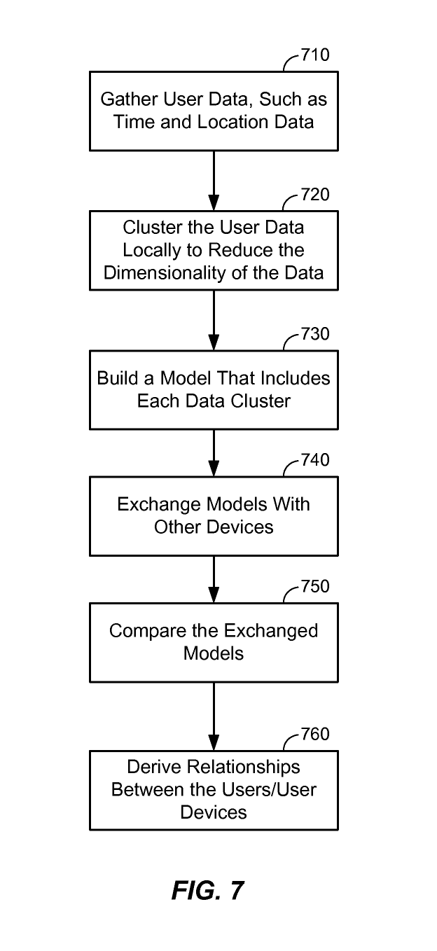

FIG. 7 illustrates an exemplary flow for determining relationships using locally built models of time-location data. The flow illustrated in FIG. 7 may be performed by the system illustrated in FIG. 6B and may be part of the clustering illustrated in FIG. 5B. The flow illustrated in FIG. 7 can be performed dynamically in real time, whereby the relationship status of the various users is constantly being updated.

At 710, each user device 610-640 gathers time and location data, either from user logs or in real time as it is generated. As described above, the time and location data may include logs of the user devices' GPS coordinates or serving cell identifiers over time, or the GPS coordinates or serving cell identifiers in real time.

At 720, each user device 610-640, specifically each user device 610-640's relationship discovery module, such as relationship discovery module 230 in FIG. 2, clusters the data locally to reduce the dimensionality of the data. Each data cluster is associated with a given user device, meaning that each data cluster is a cluster of data associated only with the user device performing the clustering (e.g., time and location data for that user device). This aspect is illustrated in FIG. 6B, which shows graphs of clustered user data beside each user device 610-640, indicating that the clustered data belongs to the particular user device. Note that the clusters created do not imply a relationship between users or user devices, but rather, serve to simplify comparing two clusters from two different user devices to determine if the user devices, or the corresponding users, are related.

At 730, each user device 610-640, specifically each user device 610-640's relationship discovery module, builds a model that includes each data cluster. As will be discussed further below, the clusters generated in 720 can be reduced to their cluster centroids, thereby reducing the dimensionality of the data, and the centroids can then be used to build the models. Each user device's model may be a neural network model that defines the transitions between that user device's centroids, for example. Alternatively, the model may simply be that user device's cluster centroids.

At 740, the user devices 610-640 exchange their models, or alternatively their centroids, with each other. They may do so by sending the models to the server 600 to distribute them to the other user devices, or over a peer-to-peer network. Alternatively, the user devices may send their models to the server 600, which will perform the remaining aspects of the flow illustrated in FIG. 7.

At 750, each user device 610-640, specifically each user device 610-640's relationship discovery module, compares the exchanged models, or alternatively the exchanged centroids. Alternatively, the server 600 may compare the exchanged models/centroids. As part of the comparing, the user devices 610-640 or the server 600 may combine the models, which may, as an example, result in a graph similar to the graphs illustrated in FIGS. 5D-E.

At 760, the user devices 610-40, specifically each user device 610-640's relationship discovery module, or the server 600 derive relationships between the user devices 610-640 and/or their respective users in accordance with a determined associating of the time and or location data corresponding to each model. As discussed above with reference to FIG. 5E, relationships between users can be determined by identifying which users share cluster centroids.

By building the models locally at each user device 610-640, the transfer of raw data to the server 600 is avoided, thereby both saving bandwidth and protecting user privacy. Further, although the disclosure thus far has referred to processing user data consisting of time and location data, any type of user data may be processed according to the aspects described herein, as will be appreciated in view of the following example.

As an example implementation, the user data of three employees may be compared. The three employees may be two junior employees and one senior employee, and both junior employees may communicate with the senior employee, but the junior employees may not communicate with each other. The user devices collect and cluster call duration and contact data and build call pattern models.

Upon comparing the models, either at any or all of the three user devices, or at a server, the models of the two junior employees may show similar sporadic call patterns, with an average call duration of two minutes and an average inter-call interval of greater than an hour. This may be in keeping with a work pattern that comprises mostly independent work, such as computer programming. Thus, even though the junior employees do not communicate with each other, by comparing their respective models and finding a large degree of similarity, it can be determined that their tasks and ranks within a company are strongly related.

Conversely, the model of the senior employee may reveal an inter-call interval of less than 15 minutes and an average call duration of six minutes, implying that this user spends much of the day communicating with many different people and has longer conversations. Thus, even though the senior manager may communicate with both of the junior employees, this user's model shows a weak relationship to the models of the junior employees. Thus, by comparing the models, the similarity or dissimilarity between different users can be determined.

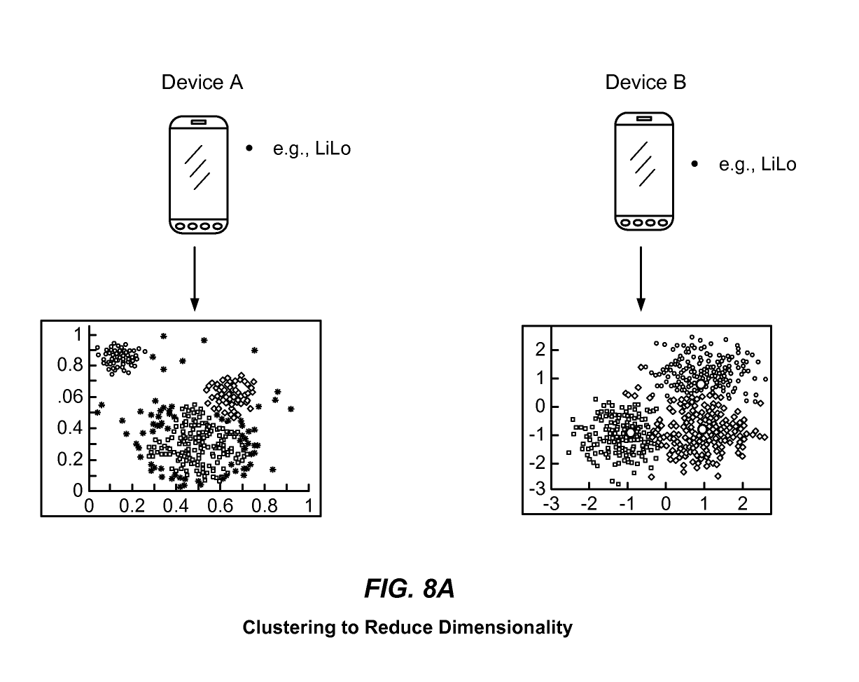

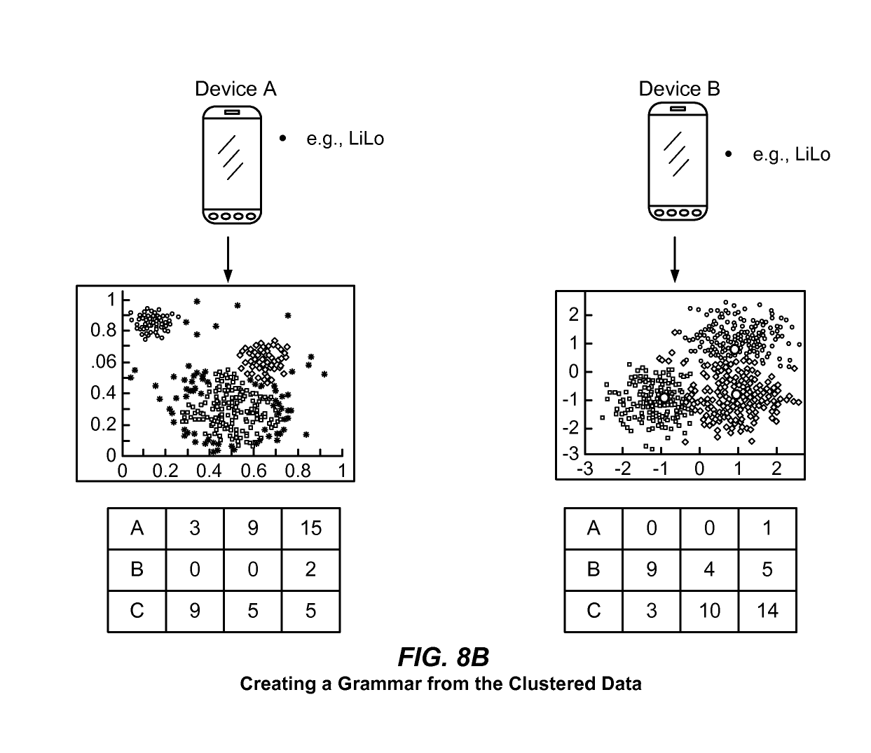

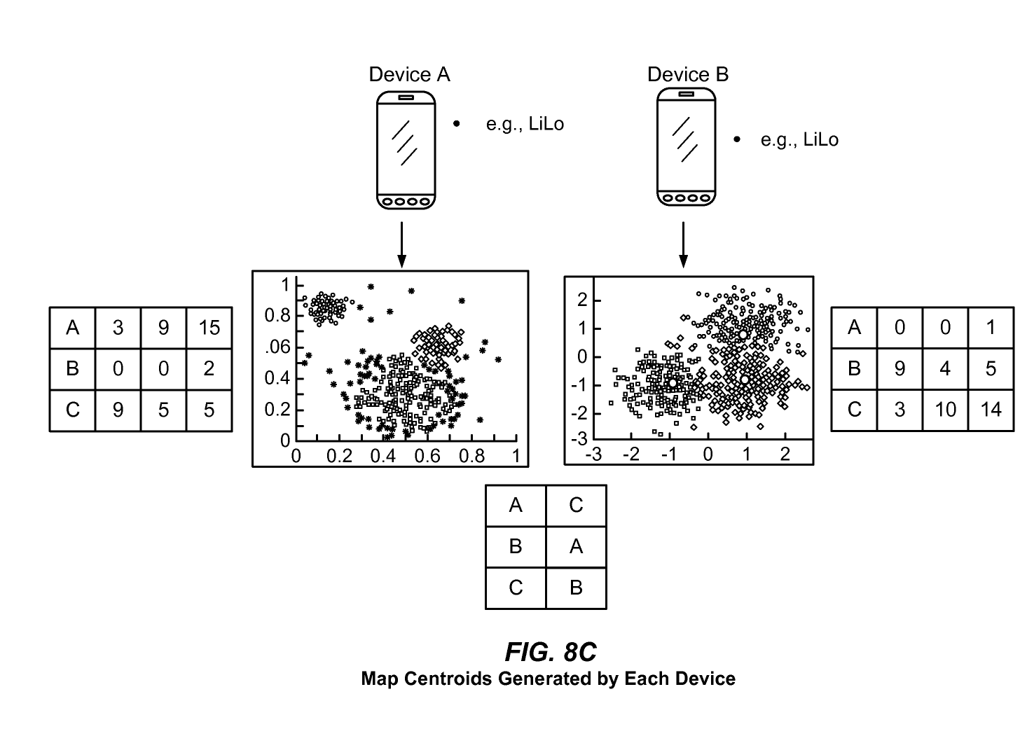

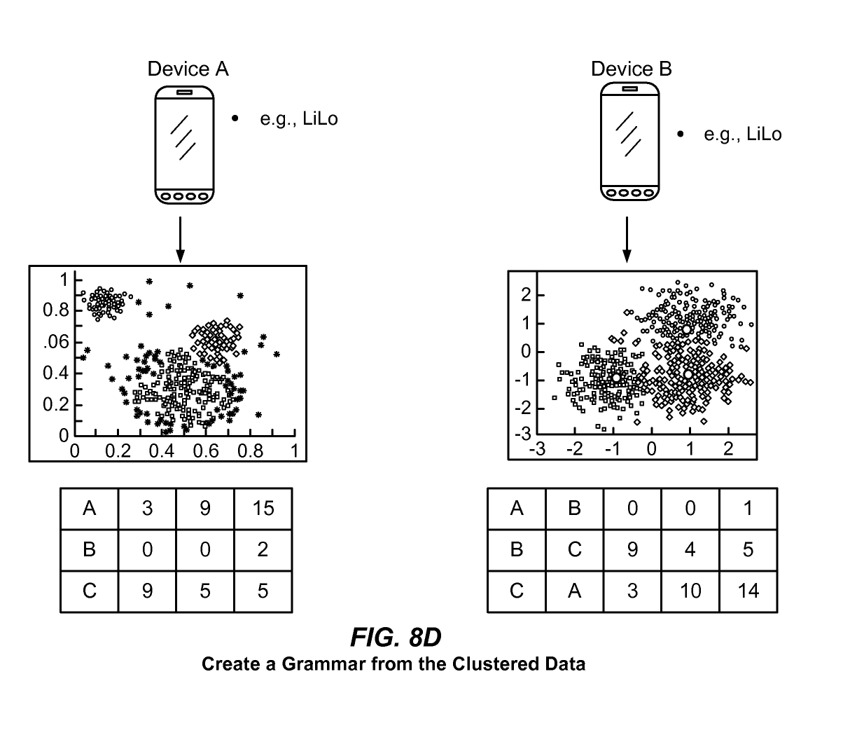

FIGS. 8A-D illustrate an exemplary process for creating a grammar from clustered data. Initially, user data from at least two user devices, e.g., user devices A and B, is compared by, for example, each user device or a server, such as server 600. The user data may include Listen-Locate (LiLo) data of the user devices or time and location data of the user devices, for example. The user devices or the server extract the user data and compare it point by point, then merge the centroids from each device with the centroids from each other device. To do so, the user devices/server may divide each number, such that some numbers from the graphs of the clusters overlap.

FIG. 8A illustrates exemplary graphs of clustered data points for user devices A and B that have been clustered to reduce dimensionality (i.e., to reduce the number of data points). Essentially, outlier data points have been eliminated, and only data points within a threshold distance of the centroid have been kept.

FIG. 8B illustrates exemplary tables for devices A and B that show a grammar created from the clustered data.

In FIG. 8C, the centroids generated by each device are mapped.

In FIG. 8D, a grammar is created from the clustered data. Each data point is mapped to the related centroid. The original data is then presented by replacing each data point with its related centroid. The resulting data set is then presented as a grammar, for example, by using a known grammar generation method, such as SEQUITUR.

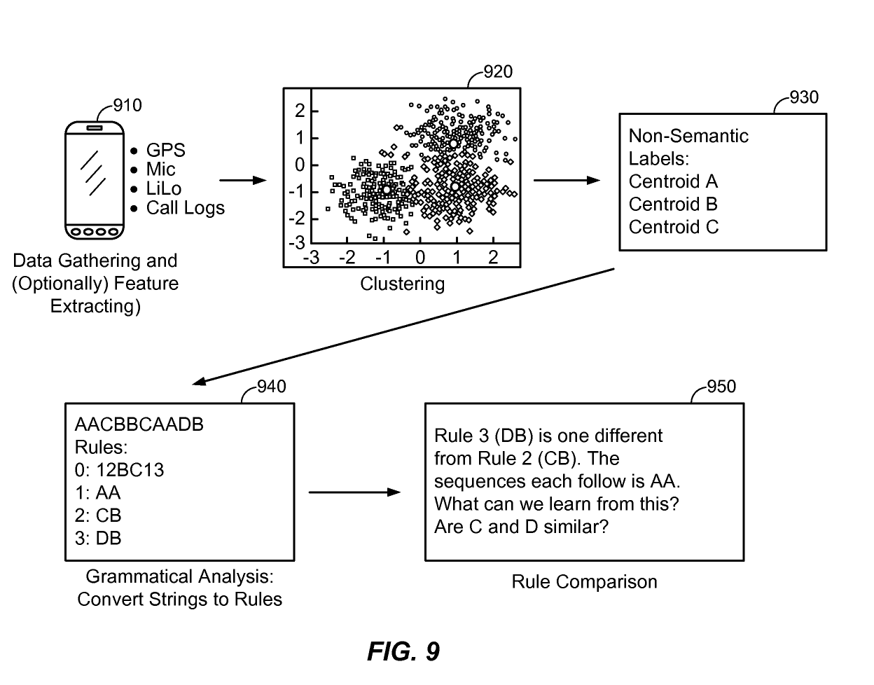

FIG. 9 illustrates an exemplary flow for creating a grammar from clustered data. The flow illustrated in FIG. 9 may be performed by a user device, such as any of user devices 610-640, or by a server, such as server 600.

At 910, the user device/server performs data gathering, such as gathering GPS data, microphone (Mic) data, LiLo data, call logs, etc. The user device/server may perform feature extraction on the data.

At 920, the user device/server, specifically the relationship discovery module, clusters the gathered data, as described above. At 930, the user device/server assigns non-semantic labels to the clusters/centroids, such as “A,” “B,” “C,” etc.

At 940, the user device/server, specifically the relationship discovery module, performs grammatical analysis on the clustered data and converts strings to rules. At 950, the user device/server compares the rules to identify relationships.

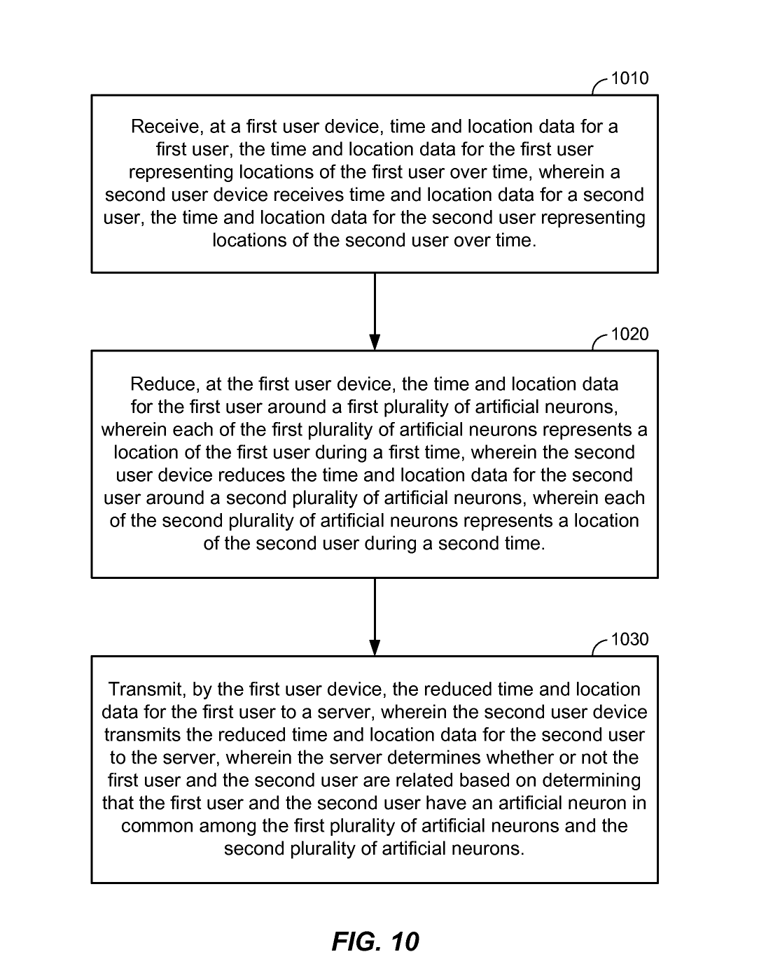

FIG. 10 illustrates an exemplary flow for deriving relationships from overlapping time and location data. The flow illustrated in FIG. 10 may be performed by a first user device, such as UE 200 or any of user devices 610-640 of FIGS. 6A and 6B.

At 1010, the first user device, for example, the relationship discovery module, such as relationship discovery module 230, receives time and location data for a first user. The time and location data for the first user may represent locations of the first user over time. A second user device, such as any other user device of user devices 610-640, may also receive time and location data for a second user. The time and location data for the second user may represent locations of the second user over time.

The location data for the first user may include audio signatures indicating a proximity of the first user device to the second user device. Likewise, the location data for the second user may include audio signatures indicating a proximity of the second user device to the first user device. In an aspect, the time and location data for the first user and the second user may be received over a period of days.

At 1020, the first user device, for example, the relationship discovery module, reduces the time and location data for the first user around a first plurality of artificial neurons. Each of the first plurality of artificial neurons may represent a location of the first user during a first time. The second user device may also reduce the time and location data for the second user around a second plurality of artificial neurons. Each of the second plurality of artificial neurons may represent a location of the second user during a second time.

Although FIG. 10 illustrates the first and second user devices reducing their respective time and location data around a first and second plurality of artificial neurons, it will be appreciated that this is only one means of reducing the dimensionality of the time and location data of the first and second user devices. In an alternative aspect, the first and second user devices may cluster their respective time and location data around a first and second plurality of cluster centroids, respectively, as described above.

At 1030, the first user device transmits the reduced time and location data for the first user to a server. The reduced time and location data for the first user may be data representing the first plurality of neurons. The second user device may also transmit the reduced time and location data for the second user to the server. The reduced time and location data for the second user may be data representing the second plurality of neurons.

The server may determine whether or not the first user and the second user are related based on determining that the first user and the second user have an artificial neuron in common among the first plurality of artificial neurons and the second plurality of artificial neurons. In an aspect, the server can map the first user and the second user to the first plurality of artificial neurons and the second plurality of artificial neurons to which time and location data for that user was assigned. In this case, determining whether the first user and the second user are related may be further based on the mapping.

The server may also determine transition distances for the first user and the second user based on the time and location data for the first user and the second user. A transition distance may represent a number of times a user device transitioned from one location to another location. Alternatively, or additionally, the server may determine GPS distances for the first user and the second user based on the time and location data for the first user and the second user. A GPS distance may represent a physical distance between a first location of a user and a second location of the user.

The server can infer social characteristics of the first user based on a number of determined relationships of the first user.

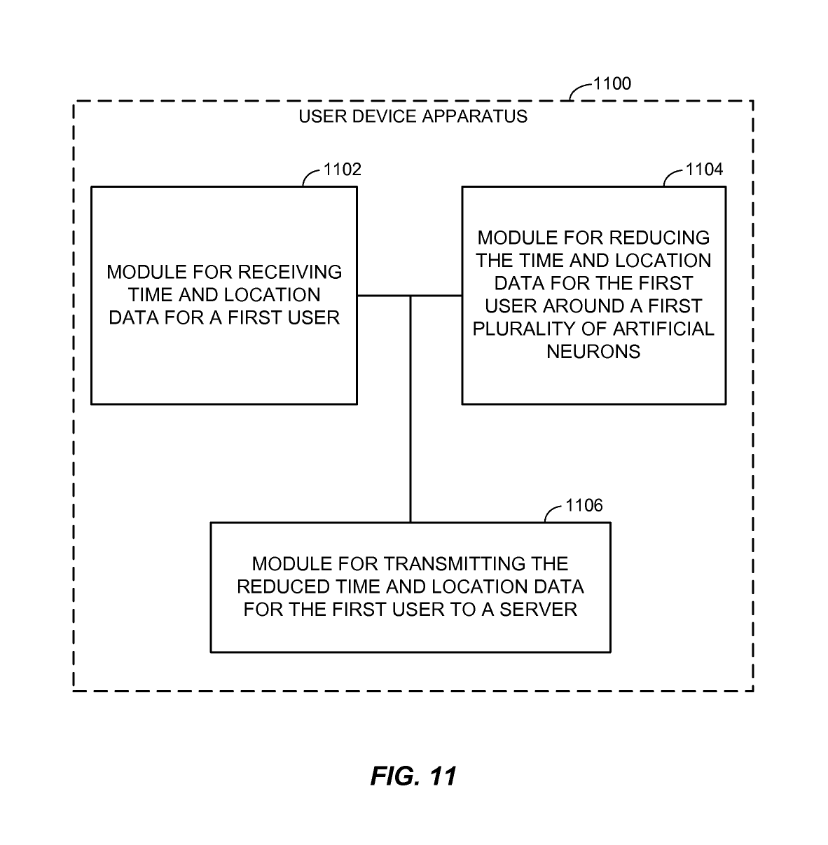

FIG. 11 illustrates an example user device apparatus 1100 represented as a series of interrelated functional modules. A module for receiving 1102 may correspond at least in some aspects to, for example, a communication device, such as WAN transceiver 204 or LAN transceiver 206, or a processing system, such as processor 210, in conjunction with a relationship discovery module, such as relationship discovery module 230, as discussed herein. A module for reducing 1104 may correspond at least in some aspects to, for example, a processing system, such as processor 210 or processor 401, in conjunction with a relationship discovery module, such as relationship discovery module 230, as discussed herein. A module for transmitting 1106 may correspond at least in some aspects to, for example, a communication device, such as WAN transceiver 204 or LAN transceiver 206, as discussed herein.

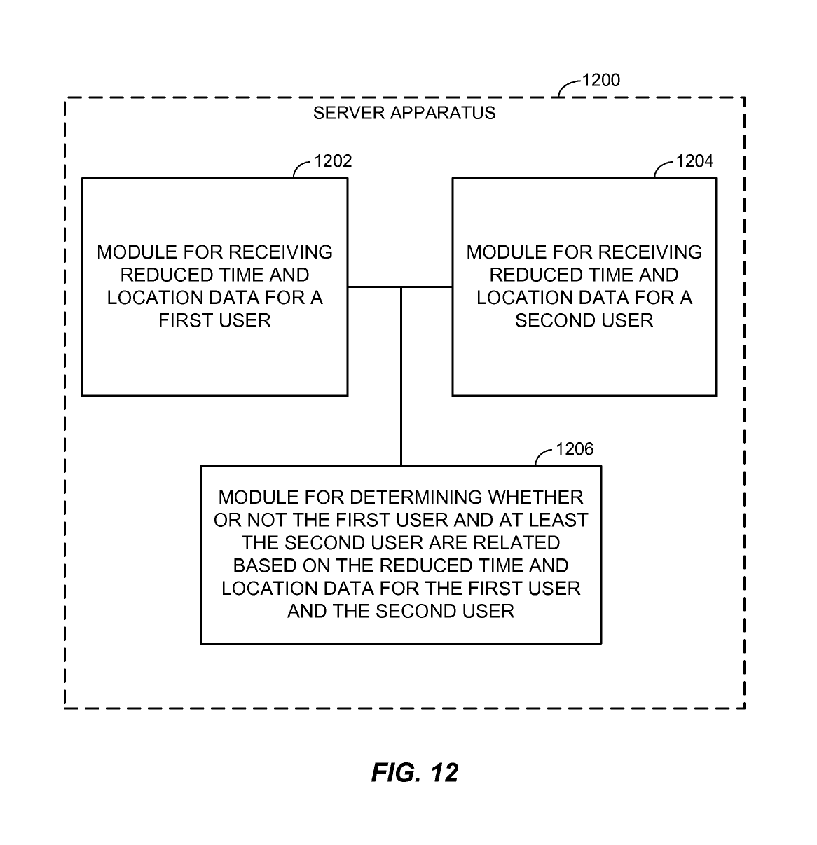

FIG. 12 illustrates an example server apparatus 1200 represented as a series of interrelated functional modules. A module for receiving 1202 may correspond at least in some aspects to, for example, a communication device, such as network access ports 404, or a processing system, such as processor 401, in conjunction with a relationship discovery module, as discussed herein. A module for receiving 1204 may correspond at least in some aspects to, for example, a communication device, such as network access ports 404, or a processing system, such as processor 401, in conjunction with a relationship discovery module, as discussed herein. A module for determining 1106 may correspond at least in some aspects to, for example, a processing system, such as processor 401, in conjunction with a relationship discovery module, as discussed herein.

The functionality of the modules of FIGS. 11-12 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIGS. 11-12, as well as other components and functions described herein, may be implemented using any suitable means. Such means also may be implemented, at least in part, using corresponding structure as taught herein. For example, the components described above in conjunction with the “module for” components of FIGS. 11-12 also may correspond to similarly designated “means for” functionality. Thus, in some aspects one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of deriving relationships from overlapping time and location data, comprising:
receiving, at a first user device, time and location data for a first user, the time and location data for the first user representing locations of the first user over time, wherein a second user device receives time and location data for a second user, the time and location data for the second user representing locations of the second user over time;
reducing, at the first user device, the time and location data for the first user around a first plurality of artificial neurons, wherein each of the first plurality of artificial neurons represents a location of the first user during a first time, wherein the second user device reduces the time and location data for the second user around a second plurality of artificial neurons, wherein each of the second plurality of artificial neurons represents a location of the second user during a second time; and
transmitting, by the first user device, the reduced time and location data for the first user to a server, wherein the second user device transmits the reduced time and location data for the second user to the server,
wherein the server determines whether or not the first user and the second user are related based on determining that the first user and the second user have an artificial neuron in common among the first plurality of artificial neurons and the second plurality of artificial neurons.

2. The method of claim 1, wherein the location data for the first user comprises audio signatures indicating a proximity of the first user device to the second user device.

3. The method of claim 1, wherein the server determines transition distances for the first user and the second user based on the time and location data for the first user and the second user, wherein a transition distance represents a number of times a user device transitioned from one location to another location.

4. The method of claim 1, wherein the server determines global positioning system (GPS) distances for the first user and the second user based on the time and location data for the first user and the second user, a GPS distance representing a physical distance between a first location of a user and a second location of the user.

5. The method of claim 1, wherein the server maps the first user and the second user to the first plurality of artificial neurons and the second plurality of artificial neurons to which time and location data for that user was assigned.

6. The method of claim 5, wherein the server determines whether the first user and the second user are related based further on the mapping.

7. The method of claim 1, wherein the server infers social characteristics of the first user based on a number of determined relationships of the first user.

8. The method of claim 1, wherein the time and location data for the first user is received over a period of days.

9. An apparatus for deriving relationships from overlapping time and location data, comprising:
a processor that receives time and location data for a first user of a first user device, the time and location data for the first user representing locations of the first user over time, and reduces the time and location data for the first user around a first plurality of artificial neurons, each of the first plurality of artificial neurons representing a location of the first user during a first time, wherein a second user device receives time and location data for a second user, the time and location data for the second user representing locations of the second user over time, and wherein the second user device reduces the time and location data for the second user around a second plurality of artificial neurons, wherein each of the second plurality of artificial neurons represents a location of the second user during a second time; and
a transceiver that transmits the reduced time and location data for the first user to a server, wherein the second user device transmits the reduced time and location data for the second user to the server,
wherein the server determines whether or not the first user and the second user are related based on determining that the first user and the second user have an artificial neuron in common among the first plurality of artificial neurons and the second plurality of artificial neurons.

10. The apparatus of claim 9, wherein the location data for the first user comprises audio signatures indicating a proximity of the first user device to the second user device.

11. The apparatus of claim 9, wherein the server determines transition distances for the first user and the second user based on the time and location data for the first user and the second user, wherein a transition distance represents a number of times a user device transitioned from one location to another location.

12. The apparatus of claim 9, wherein the server determines global positioning system (GPS) distances for the first user and the second user based on the time and location data for the first user and the second user, a GPS distance representing a physical distance between a first location of a user and a second location of the user.

13. The apparatus of claim 9, wherein the server maps the first user and the second user to the first plurality of artificial neurons and the second plurality of artificial neurons to which time and location data for that user was assigned.

14. The apparatus of claim 13, wherein the server determines whether the first user and the second user are related based further on the mapping.

15. The apparatus of claim 9, wherein the server infers social characteristics of the first user based on a number of determined relationships of the first user.

16. The apparatus of claim 9, wherein the processor receives the time and location data for the first user over a period of days.

17. An apparatus for deriving relationships from overlapping time and location data, comprising:
means for receiving, at a first user device, time and location data for a first user, the time and location data for the first user representing locations of the first user over time, wherein a second user device receives time and location data for a second user, the time and location data for the second user representing locations of the second user over time;
means for reducing, at the first user device, the time and location data for the first user around a first plurality of artificial neurons, wherein each of the first plurality of artificial neurons represents a location of the first user during a first time, wherein the second user device reduces the time and location data for the second user around a second plurality of artificial neurons, wherein each of the second plurality of artificial neurons represents a location of the second user during a second time; and
means for transmitting, by the first user device, the reduced time and location data for the first user to a server, wherein the second user device transmits the reduced time and location data for the second user to the server,
wherein the server determines whether or not the first user and the second user are related based on determining that the first user and the second user have an artificial neuron in common among the first plurality of artificial neurons and the second plurality of artificial neurons.

18. The apparatus of claim 17, wherein the location data for the first user comprises audio signatures indicating a proximity of the first user device to the second user device.

19. The apparatus of claim 17, wherein the server determines transition distances for the first user and the second user based on the time and location data for the first user and the second user, wherein a transition distance represents a number of times a user device transitioned from one location to another location.

20. The apparatus of claim 17, wherein the server determines global positioning system (GPS) distances for the first user and the second user based on the time and location data for the first user and the second user, a GPS distance representing a physical distance between a first location of a user and a second location of the user.

21. The apparatus of claim 17, wherein the server maps the first user and the second user to the first plurality of artificial neurons and the second plurality of artificial neurons to which time and location data for that user was assigned.

22. The apparatus of claim 21, wherein the server determines whether the first user and the second user are related based further on the mapping.

23. The apparatus of claim 17, wherein the server infers social characteristics of the first user based on a number of determined relationships of the first user.

24. The apparatus of claim 17, wherein the means for receiving receives the time and location data for the first user over a period of days.

25. A non-transitory computer-readable medium for deriving relationships from overlapping time and location data, comprising:
at least one instruction for receiving, at a first user device, time and location data for a first user, the time and location data for the first user representing locations of the first user over time, wherein a second user device receives time and location data for a second user, the time and location data for the second user representing locations of the second user over time;
at least one instruction for reducing, at the first user device, the time and location data for the first user around a first plurality of artificial neurons, wherein each of the first plurality of artificial neurons represents a location of the first user during a first time, wherein the second user device reduces the time and location data for the second user around a second plurality of artificial neurons, wherein each of the second plurality of artificial neurons represents a location of the second user during a second time; and
at least one instruction for transmitting, by the first user device, the reduced time and location data for the first user to a server, wherein the second user device transmits the reduced time and location data for the second user to the server,
wherein the server determines whether or not the first user and the second user are related based on determining that the first user and the second user have an artificial neuron in common among the first plurality of artificial neurons and the second plurality of artificial neurons.

26. The non-transitory computer-readable medium of claim 25, wherein the location data for the first user comprises audio signatures indicating a proximity of the first user device to the second user device.

27. The non-transitory computer-readable medium of claim 25, wherein the server determines transition distances for the first user and the second user based on the time and location data for the first user and the second user, wherein a transition distance represents a number of times a user device transitioned from one location to another location.

28. The non-transitory computer-readable medium of claim 25, wherein the server maps the first user and the second user to the first plurality of artificial neurons and the second plurality of artificial neurons to which time and location data for that user was assigned.

29. The non-transitory computer-readable medium of claim 25, wherein the server infers social characteristics of the first user based on a number of determined relationships of the first user.

30. The non-transitory computer-readable medium of claim 25, wherein the time and location data for the first user is received over a period of days.
